(19) United States
(12) Patent Application Publication
(10) Pub. No.: US 2024/0320033 A1
(43) Pub. Date: Sep. 26, 2024

(54) PROCESSING SPARSE LINEAR SYSTEMS USING DISTRIBUTED RESOURCES

(71) Applicant: International Business Machines Corporation, Armonk, NY (US)

(72) Inventors: Lior Horesh, North Salem, NY (US); Vasileios Kalantzis, White Plains, NY (US); Shashanka Ubaru, Ossining, NY (US)

(21) Appl. No.: 18/187,172

(22) Filed: Mar. 21, 2023

(51) Int. Cl. G06F 9/48; G06F 9/30; G06F 9/355

(52) U.S. Cl. CPC G06F 9/4881; G06F 9/30036; G06F 9/3555

(57) ABSTRACT

Solving linear systems by sending matrix data from a first computer to a second computer, directing the second computer in determining a solution to a parallel computing task for the matrix data, receiving the solution by the first computer, determining a solution to a non-parallel computing task for the matrix data using the first computer, and providing the solution to the non-parallel computing task.

### FIELD OF THE INVENTION

The disclosure relates generally to solving sparse symmetric linear systems. The invention relates particularly to securely solving sparse symmetric linear systems using hybrid cloud architectures.

### BACKGROUND

Hybrid cloud systems include both private and public cloud components enabling users to take advantage of the quantity of public cloud resources for work having low levels of security needs, while also maintaining the security of their information by retaining that information on their private cloud.

### SUMMARY

The following presents a summary to provide a basic understanding of one or more embodiments of the disclosure. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatuses and/or computer program products enable the solving of linear systems using networked computer systems.

Aspects of the invention disclose methods, systems and computer readable media associated with solving linear systems by sending matrix data from a first computer to a second computer, directing the second computer in determining a solution to a parallel computing task for the matrix data, receiving the solution by the first computer, determining a solution to a non-parallel computing task for the matrix data using the first computer, and providing the solution to the non-parallel computing task.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 provides a schematic illustration of a computing environment, according to an embodiment of the invention.

FIG. 2 provides a flowchart depicting an operational sequence, according to an embodiment of the invention.

FIG. 3 depicts a cloud computing environment, according to an embodiment of the invention.

FIG. 4 depicts abstraction model layers, according to an embodiment of the invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

The solution of sparse linear systems of equations has importance for many applications in science and engineering. The proposed invention describes systems and methods enable secure, rapid solutions to such linear systems on hybrid cloud architectures.

Aspects of the present invention relate generally to solving systems of linear equations and, more particularly, to the utilization of hybrid cloud environments in solving sparse symmetric linear systems. In embodiments, systems and methods send matrix data from a first computer to a second computer, direct the second computer to determine a solution to a parallel computing task for the matrix data, receive the solution by the first computer, determine a solution to a non-parallel computing task for the matrix data using the first computer, and providing the solution to the non-parallel computing task to a user.

According to aspects of the invention, the solver system automatically and dynamically utilizes available public cloud resources in the performance of parallel tasks associated with solving the linear system of equations. The proposed system may utilize but does not require sophisticated encryption mechanisms. Transmitted data may be secured using simple scaling mechanisms. In this manner, implementations of the invention divide the tasks associated with determining a solution, transmit the data necessary to solve parallel aspects of the solution to available public cloud servers, retain the non-parallel aspects of the solution tasks on secure private servers, and enable the determination and provision of a solution to the system of equations.

In accordance with aspects of the invention there a method automatically solves linear systems of equations while utilizing available cloud resources, the method comprises: sending matrix data from a first computer to a second computer, directing the second computer in determining a solution to a parallel computing task for the matrix data, receiving the solution by the first computer, determining a solution to a non-parallel computing task for the matrix data using the first computer, and providing the solution to the non-parallel computing task.

Aspects of the invention provide an improvement in the technical field of equation solver systems. Conventional solver systems utilize local resources in solving parallel and non-parallel tasks associated with determining a system solution or utilize remote cloud resources in determining the overall solution. In many cases, transmitting data and solving the system remotely exposes the user's information to a risk of loss during transmission of the data and the return transmission of the solution. Disclosed methods separate parallel tasks and non-parallel tasks, retaining the final non-parallel tasks and transmitting only the data necessary for accomplishing parallel tasks, which data may be easily masked. As a result, the solution may be more securely determined.

Aspects of the invention also provide an improvement to overall computer system functionality. In particular, implementations of the invention provide a specific improvement to the way solver systems operate, embodied in the transmission of data associated to parallel tasks to multiple available cloud resources, enabling a rapid solution to the parallel tasks which may then be utilized by a private computing resource in determining a solution for the non-parallel aspects of the solution for the system of linear equations. In embodiments, the system distributes the parallel tasks across all available cloud resources while only needing to provide easily masked data associated with the parallel tasks and not information associated with the underlying system of equations and the underlying problem associated with that system of equations. In this manner, embodiments of the invention enable rapid and secure determination of solutions for sparse symmetric linear systems.

In an embodiment, one or more components of the system can employ hardware and/or software to solve problems that are highly technical in nature (e.g., sending matrix data from a first computer to a second computer, directing the second computer in determining a solution to a parallel computing task for the matrix data, receiving the solution by the first computer, determining a solution to a non-parallel computing task for the matrix data using the first computer, and providing the solution to the non-parallel computing task, etc.). These solutions are not abstract and cannot be performed as a set of mental acts by a human due to the processing capabilities needed to facilitate determination of linear system solutions. Further, some of the processes performed may be performed by a specialized computer for carrying out defined tasks related to solve linear systems. For example, a specialized computer can be employed to carry out tasks related to determine linear system solutions, or the like.

In an embodiment, for a sparse symmetric linear system described as: Ax=b; A∈R^{n×n}; x∈Rⁿ, and b∈Rⁿ:

$$[ \begin{matrix}{B}_{1} & ⋯ & & {E}_{1} \\ ⋮ & ⋱ & & ⋮ \\ & & {B}_{p} & {E}_{p} \\ {E}_{1}^{T} & ⋯ & {E}_{p}^{T} & C\end{matrix} ] [ \begin{matrix}{u}_{1} \\ ⋮ \\ {u}_{p} \\ f\end{matrix} ] = [ \begin{matrix}{b}_{1} \\ ⋮ \\ {b}_{p} \\ f\end{matrix} ]$$

$$A \times b$$

Disclosed systems utilize available cloud resources, such as public cloud resources, to perform parallel tasks and on-premise resources to perform critical non-parallel tasks.

In an embodiment, step 1: for j=1 . . . p, methods seek to solve Bⱼûⱼ=bⱼ. Step 2: form the matrix S=C−E^{T}B⁻¹E, and solve Sy=f−E^{T}û. Step 3: for j=1; : : : ; p: methods solve Buⱼ=bⱼ·Eⱼy. The matrix S can be written as S=C−Σⱼ₌₁^{j=p}Eⱼ^{T}Bⱼ⁻¹E^{j}, and each term Eⱼ^{T}Bⱼ⁻¹Eⱼ, can be computed in parallel. In an embodiment, method also perform steps 1 and 3 in parallel. In an embodiment. methods and systems distribute the parallel execution of steps 1 and 3, as well as the computation of each term Eⱼ^{T}Bⱼ⁻¹Eⱼ to different available cloud servers. In this embodiment, the Schur, non-parallel complement linear system can not be easily solved in parallel but the remaining tasks can. Reserving the non-parallel portion of the solution determination to local resources reduces the likelihood that the security of the overall solution can be compromised.

In an embodiment, the j′th public cloud server computes each term Eⱼ^{T}Bⱼ⁻¹Eⱼ; and solves the linear system Bⱼûⱼ=bⱼ, then sends Eⱼ^{T}Bⱼ⁻¹Eⱼ and ûⱼ back to the local server. In this embodiment, the local server computes S=C−E^{T}B⁻¹E, and solves Sy=f−E^{T}û. The local server then sends y to all public cloud servers and receives the solution Buⱼ=bⱼ−Eⱼy from the j′th cloud server.

In an embodiment, rather than providing the public cloud servers with Bⱼ. Eⱼ, and bⱼ the local server uploads matrices a₁(j)Bⱼ; a₂(j)Eⱼ and a₂(j)bⱼ instead. Methods randomly select chosen scalars aₖ(j)∈(1, 2), known only to the local server. In this embodiment, the local server immediately overwrites Eⱼ^{T}Bⱼ⁻¹Eⱼ and ûj, with a₁(j) Eⱼ^{T}Bⱼ⁻¹Eⱼ/a₂²(j) and a1(j)/a2(j)ûj upon receipt of the former. Similarly, the local server uploads a₂(j)y to the public cloud server and receives uⱼ which it overwrites with a₁(j)/a₂(j)uⱼ.

A single hybrid cloud may eb extended to a hybrid multi-cloud wherein multiple public cloud service providers combine to meet the needs of the user. In such a scenario, a client may have data residing upon multiple different cloud services and may utilize multiple cloud services in performing the disclosed methods.

In an embodiment, methods and systems may mask uploaded data by applying scaling matrices Bⱼ and Eⱼ using the mean non-zero entries of each matrix. Alternatively, the matrices may be masked by applying a unitary transformation. In an embodiment, methods apply an encryption algorithm to the data prior to transmitting it to the cloud servers for processing.

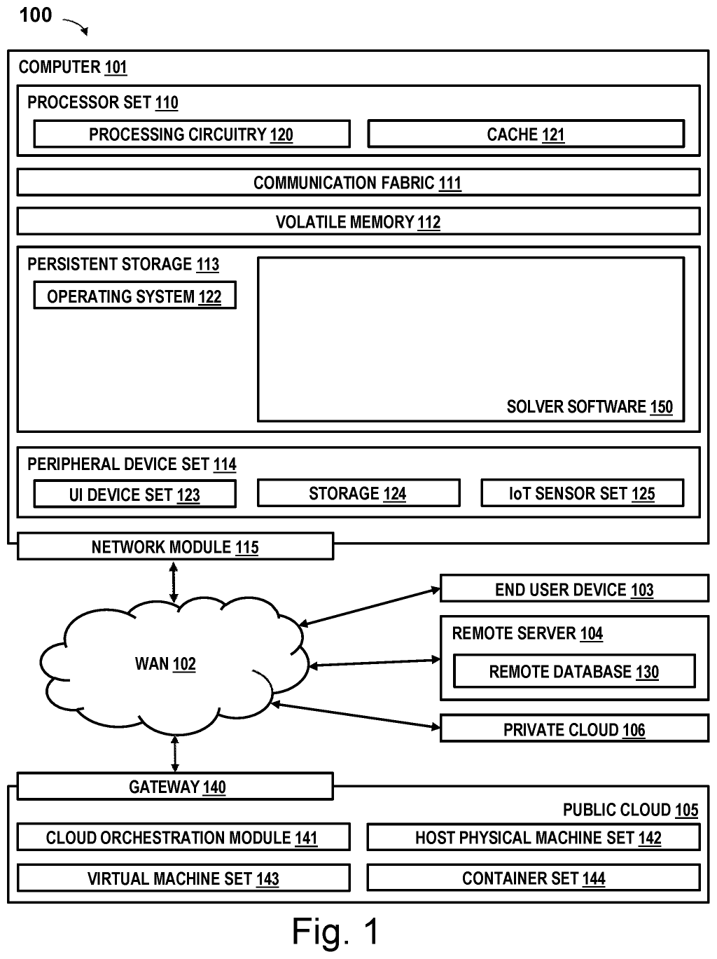

As shown in FIG. 1, computing environment 100 contains an example of an environment for the execution of at least some of the computer code involved in performing the inventive methods, such as sparse linear systems solver software 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

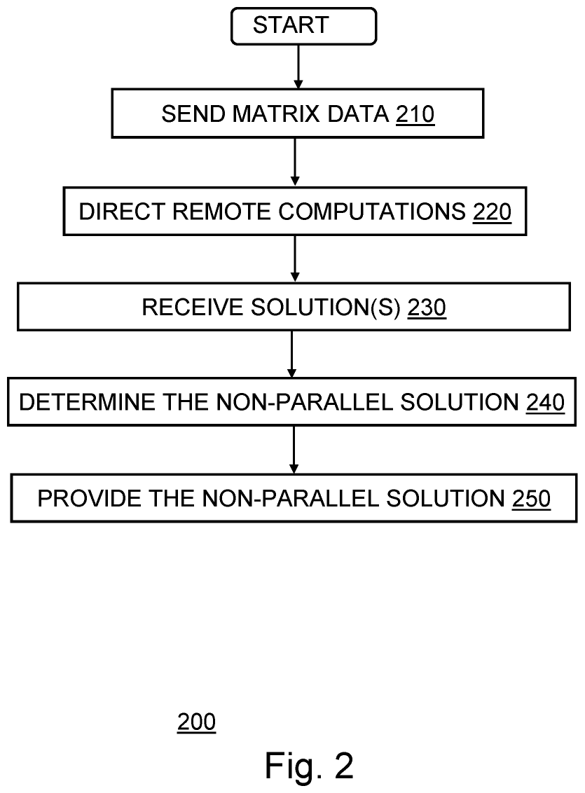

FIG. 2 provides a flowchart 200, illustrating exemplary activities associated with the practice of the disclosed inventions. After program start, at block 210, solver 150 of FIG. 1, of a local first computer sends matrix data from a local computer resource to a second computer, typically a cloud resource. In this manner the parallel tasks associated with solving a set of system equations may be processed in parallel as each possible parallel task may be sent to a separate cloud resource for processing.

At block 220, methods of the solver 150 direct the second computer(s) in processing the matrix data to yield the desired solution. At block 230, the local computer receives the solution(s) back from the remote computers after their processing steps are complete. At block 240, the local computer utilizes the received solution in determining the non-parallel solution to the system of equations. At block 250, the local computer provides the non-parallel solution to the user for application to the problem.

Measuring the importance of the vertices of a graph (centrality) is a common task arising in graph analytics. Each vertex of the graph is associated with a real value and the goal is to identify (rank) the vertices with the leading scores, i.e., highest centrality scores. The applications of such centrality scores include the identification of the most influential nodes in social networks, the main hubs of road and urban networks, as well as the most important proteins in cell networks.

One technique to compute centrality scores is via a generalization of degree centrality, known as Katz centrality. More specifically, let A∈Rn×n denote the adjacency matrix associated with the graph whose vertex centralities we want to compute. Katz centrality computes the centralities by solving the linear system (I−αA)x=b, where b is an n-length vector of all ones, and α∈R is an attenuation factor that is larger than zero and less than the reciprocal of the spectral radius of the adjacency matrix A. Most commonly, a is chosen equal to 0.85. After solving the above linear system, the centrality score of vertex ‘i’ is equal to the ith entry of the vector x. Disclosed embodiments enable the determination of network centralities in hybrid cloud architectures.

Controlling the dynamics of effects propagated across a network may begin with the identification of those nodes of the network which have the greatest influence on the target effects. Katz centrality may be used as an indicator of the relative influence of respective network nodes. The Katz centrality associated the most influential nodes of a networked system with those entries of the solution to the system of equations representing the networked system having the largest values. For example, those entries of a solution having the largest values represent the most influential nodes of the associated network. Efforts to impact the targeted effect associated with the network focused upon the identified influential nodes have the greatest likelihood of success. In an embodiment, methods solve a system of equations associated with an effect expressed across a network, identify the most influential networked nodes associated with the targeted effect expressed across the network, and enable targeting that effect by taking actions at, or against, the identified influential nodes of the network. In this embodiment, such actions at or against the identified nodes may include steps taken relative to the targeted effect to ameliorate, enhance, or accelerate the targeted effect.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

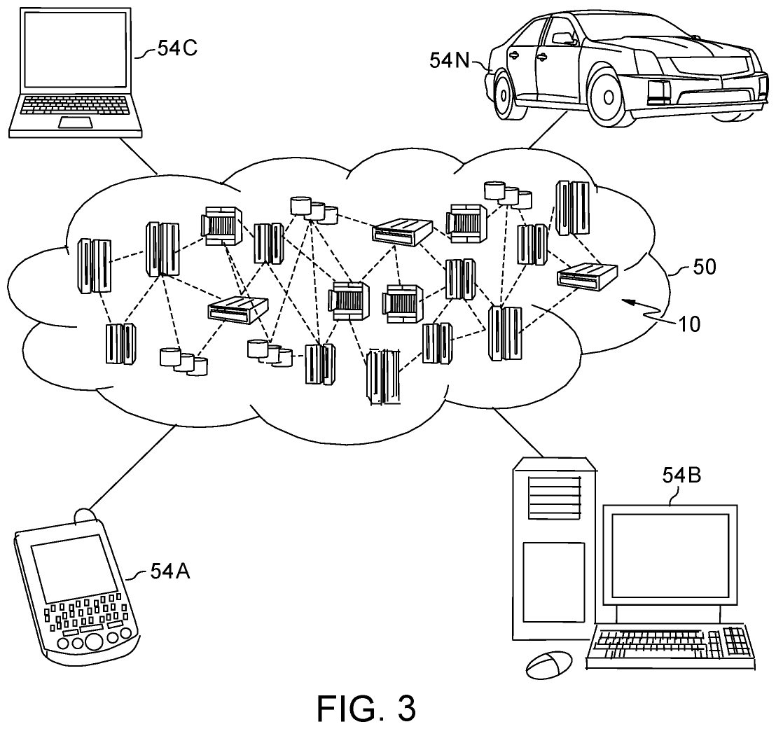

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

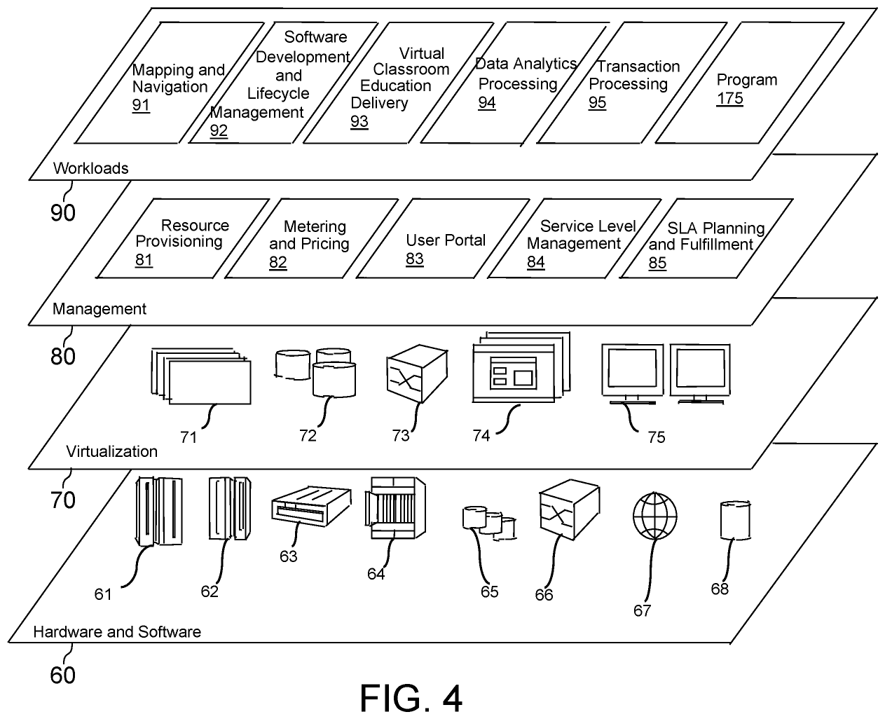

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and training data set selection program 175.

The present invention may be a system, a method, and/or a computer program product at any possible technical detail level of integration. The invention may be beneficially practiced in any system, single or parallel, which processes an instruction stream. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, or computer readable storage device, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions collectively stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for solving linear systems, the method comprising:
sending, by one or more computer processors, matrix data from a first computer to a second computer;
directing, by the one or more computer processors, the second computer in determining a solution to a parallel computing task for the matrix data using the second computer;
receiving, by the one or more computer processors, the solution by the first computer;
determining, by the one or more computer processors, a solution to a non-parallel computing task for the matrix data using the first computer; and
providing, by the one or more computer processors, the solution to the non-parallel computing task.

2. The computer implemented method according to claim 1, further comprising masking, by the one or more computer processors, the matrix data; and sending the masked matrix data to the second computer.

3. The computer implemented method according to claim 2, wherein the masking comprises applying a linear scaling to the matrix data.

4. The computer implemented method according to claim 2, wherein the masking comprises scaling the matrix data using a matrix mean non-zero entry.

5. The computer implemented method according to claim 2, wherein the masking comprises applying a unitary transformation to the matrix data.

6. The computer implemented method according to claim 1, further comprising encrypting, by the one or more computer processors, the matrix data.

7. The computer implemented method according to claim 1, further comprising providing, by the one or more computer processors, the solution to the non-parallel problem to the second computer; and receiving, by the one or more computer processors, a solution based upon the solution to the non-parallel problem from the second computer.

8. A computer program product for solving linear systems, the computer program product comprising one or more computer readable storage media and collectively stored program instructions on the one or more computer readable storage media, the stored program instructions which, when executed, cause one or more computer systems to:
send matrix data from a first computer to a second computer;
direct the second computer to determine a solution to a parallel computing task for the matrix data using the second computer;
receive the solution to the first computer;
determine a solution to a non-parallel computing task for the matrix data using the first computer; and
provide the solution to the non-parallel computing task.

9. The computer program product according to claim 8, the stored program instruction further comprising program instructions which, when executed cause the one or more computer systems to mask the matrix data; and program instructions to send the masked matrix data to the second computer.

10. The computer program product according to claim 9, wherein the masking comprises applying a linear scaling to the matrix data.

11. The computer program product according to claim 9, wherein the masking comprises scaling the matrix data using a matrix mean non-zero entry.

12. The computer program product according to claim 9, wherein the masking comprises applying a unitary transformation to the matrix data.

13. The computer program product according to claim 8, the stored program instructions further comprising program instructions which, when executed cause the one or more computer systems to encrypt the matrix data.

14. The computer program product according to claim 8, the stored program instructions further comprising program instructions which, when executed cause the one or more computer systems to provide the solution to the non-parallel problem to the second computer; and program instructions to receive a solution based upon the solution to the non-parallel problem from the second computer.

15. A computer system for solving linear systems, the computer system comprising:
one or more computer processors;
one or more computer readable storage devices; and
stored program instructions on the one or more computer readable storage devices for execution by the one or more computer processors, the stored program instructions which, when executed, cause the one or more computer processors to:
send matrix data from a first computer to a second computer;
direct the second computer to determine a solution to a parallel computing task for the matrix data using the second computer;
receive the solution to the first computer;
determine a solution to a non-parallel computing task for the matrix data using the first computer; and
provide the solution to the non-parallel computing task.

16. The computer system according to claim 15, the stored program instruction further comprising program instructions which, when executed cause the one or more computer processors to mask the matrix data; and program instructions to send the masked matrix data to the second computer.

17. The computer system according to claim 16, wherein the masking comprises applying a linear scaling to the matrix data.

18. The computer system according to claim 16, wherein the masking comprises scaling the matrix data using a matrix mean non-zero entry.

19. The computer system according to claim 16, wherein the masking comprises applying a unitary transformation to the matrix data.

20. The computer system according to claim 15, the stored program instructions further comprising program instructions which, when executed cause the one or more computer processors to encrypt the matrix data.
